(19) United States
(12) Patent Application Publication
(10) Pub. No.: US 2005/0163363 A1
(43) Pub. Date: Jul. 28, 2005

(54) Continuous filter rod testing

(75) Inventors: Dierk Schroder, Hamburg (DE); Max Lammel, Schwarzenbek (DE); Siegfried Hapke, Geesthacht (DE)

Correspondence Address: VENABLE LLP, P.O. BOX 34385, WASHINGTON, DC, 20045-9998, US

(73) Assignee: HAUNI Maschinenbau AG, Hamburg (DE)

(21) Appl. No.: 11/030,902

(22) Filed: Jan. 10, 2005

(30) Foreign Application Priority Data
Jan. 22, 2004 (DE) 10-2004-003 447.8

(51) Int. Cl. G06K 9/00; A24D 1/04

(52) U.S. Cl. 382/141; 131/202

(57) ABSTRACT

An apparatus for testing a rod-shaped article in the tobacco industry includes a source of light for illuminating the rod-shaped article. An imaging device is disposed for forming an image of at least a portion of light transmitted through the article. A sensor has a surface on which the image is formed and detects an intensity of the light in the image.

### CROSS-REFERENCE TO RELATED APPLICATION

This application claims the priority of German Patent Application No. 102 004 003 447.8 filed on Jan. 22, 2004. The disclosures of the foregoing application and each U.S. and foreign patent and patent application mentioned herein are incorporated herein by reference.

### BACKGROUND OF THE INVENTION

The invention relates to an apparatus for testing a rod-shaped article in the tobacco industry, in particular a continuous filter rod and preferably a multi-segmented continuous filter rod. Such an apparatus comprises a light source for illuminating the articles with the so-called light-transmission method and a sensor for at least partially detecting the intensity of the light from the light source that exits the article. The invention furthermore relates to a method for testing a rod-shaped article in the tobacco industry, in particular a continuous filter rod and preferably a multi-segmented continuous filter rod, wherein the article is illuminated by means of a light source with the light-transmission method and wherein the intensity of the light transmitted by the light source that exits the article is detected at least in part with the aid of a sensor. The invention also relates to a machine in the tobacco industry, in particular a multi-segmented filter making machine.

German unexamined published patent application DE-A-27 32 520 discloses a method for testing a continuously advancing rod, in particular a continuous cigarette filter rod having successively following sections containing material of different composition and/or design. According to this method, at least one light beam is introduced into the continuous filter rod in a plane extending approximately perpendicular to the longitudinal axis of the continuous filter rod and the intensity or brightness of the light exiting the continuous filter rod is measured with a photo-electronic component, at a location on the outside of the continuous filter rod that is disposed approximately in the same plane as the plane for the light-beam, but at a distance to the location where light is introduced. The measuring result is then evaluated in an evaluation circuit that is electrically connected to the photo-electronic component.

U.S. Pat. No. 4,001,579, which corresponds to German Patent DE-C-25 10 502, furthermore discloses a device for monitoring composite cigarette filters during the manufacturing process, following a continuous insertion of the filter elements into a tubular sleeve.

When manufacturing cigarette filters and/or multi-segmented filters having at least two sections with different material composition in the longitudinal direction, the difficulty arises that the filter segments cut from a continuously-produced cigarette filter rod should not only have a constant length, but that the cuts should always be made at the same location on a specific filter section to obtain filter segments with identical, predetermined composition.

The cigarette industry has an increasing tendency to use multi-segmented filters produced with the extrusion method in so-called multi-segmented filter making machines. With this method, the endless filter rod, formed with different types of filter segments, must be cut into individual segments at the correct or corresponding locations, so that the cut filter segments can be attached to the cigarettes on a filter tipping machine, wherein the accuracy of the cutting position is a decisive quality criterion. A closed loop, in which the filter segment measurement is made with an optical sensor, is used on a multi-segmented filter making machine to determine the position for executing the cut. The accuracy of the cutting position control thus depends decisively on the accuracy of the filter-segment measurement.

The segment-measuring accuracy requirements are steadily increasing for multi-segmented continuous filter rods, on the one hand because of higher accuracy requirements for measuring the position of the filter segments and, on the other hand, because of the need to be able to detect low-contrast filter transitions. Known measuring techniques are not suitable for this.

### SUMMARY OF THE INVENTION

It is an object of the present invention to improve the accuracy of detecting segments in a multi-segmented continuous filter rod, so as to control a cutting device.

The above and other objects are accomplished according to the invention by the provision of an apparatus for testing a rod-shaped article in the tobacco industry, comprising: a source of light for illuminating the rod-shaped article; an imaging device disposed for forming an image of at least a portion of light transmitted through the article; and a sensor having a surface on which the image is formed and detecting an intensity of the light in the image.

The measure according to the invention thus results in minimizing the aperture angle of the receiving optic, so that an imaging optic or device can be used on the receiving side. A smaller area of brightness is therefore generated by the light source in the article and is recorded, for example on a photo-sensitive layer or surface of a photoelectric sensor.

The imaging device is advantageously provided with at least one lens, thereby forming an optical device.

The light source, imaging device and sensor constitute a measuring device. According to an exemplary embodiment, at least two of the measuring devices are provided for the article.

Several measuring devices in particular are arranged transverse to the longitudinal axis of the article, preferably in a single plane.

A propagating light cone generated by the light source is additionally minimized if the light source is a laser light source, so that the multi-segmented filter rod or the rod-shaped article to be tested is admitted with light in the manner of a fan or point, wherein the measuring quality is improved as a result of reducing the propagating cone of light in the article.

At least one diaphragm is furthermore provided in particular in the beam path between the imaging device and the sensor.

According to another exemplary embodiment, there is provided a machine in the tobacco industry, in particular a multi-segmented filter making machine, forming a combination with the above described apparatus of the invention for testing rod-shaped articles in the tobacco industry.

According to yet another exemplary embodiment of the invention there is provided a method for testing a rod-shaped article in the tobacco industry, in particular a continuous filter rod and preferably a multi-segmented continuous filter rod. The method includes the steps of illuminating the article with light; imaging, at least in part, light which is transmitted through the article onto a sensor; and detecting an intensity of the imaged light with the sensor.

It is furthermore advantageous if a laser light source is used in the illuminating step to illuminate the article.

According to an exemplary embodiment of the method, it is favorable if the article is illuminated by means of at least two light sources.

### BRIEF DESCRIPTION OF THE DRAWINGS

The invention is explained in the following with the aid of the exemplary embodiments shown in the drawings and is described without restricting the general inventive idea, wherein for all inventive details not described further in the text may be discerned from the drawings.

FIG. 1 is a longitudinal section through an embodiment of a testing apparatus according to the prior art.

FIG. 2 is a longitudinal section through an embodiment of an apparatus according to the invention.

FIG. 3 is a cross sectional view through a second embodiment of a testing apparatus according to the invention.

### DETAILED DESCRIPTION OF THE INVENTION

In the following drawings, the same or similar elements or parts are given the same reference numbers and will not be introduced again.

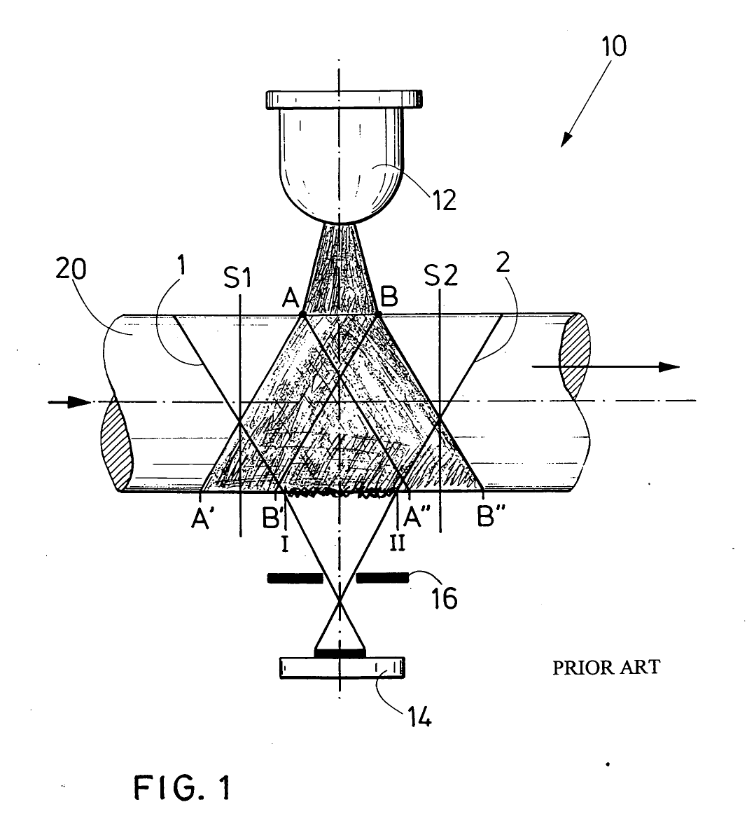

FIG. 1 shows a longitudinal section through a testing apparatus 10, comprising a light source 12, for example a light-emitting diode, and a sensor 14 that is arranged opposite the light source 12. A continuous filter rod 20, preferably consisting of several filter segments, is conveyed through the area between the light source 12 and the sensor 14. The continuous filter rod 20 is illuminated by light transmitted by the light source 12. In the process, the cone of light exiting the light source 12 creates an illuminated zone A-B in which light enters the continuous filter rod 20 in the rod-conveying or conveying direction of the continuous filter rod 20. As a result of scattering in the filter material of the continuous filter rod 20, the light spreads so-to-speak conically in the continuous filter rod 20 or the material, such that the light entering at point A exits between the points A′ and A″ on the opposite side of continuous filter rod 20. In the same way, the light entering at point B is distributed conically between points B′ and B″ on the opposite side of the continuous filter rod 20. On the whole, the light distribution ranges from point A′ to point B″ on the side where the light leaves the continuous filter rod.

On the receiving side, a diaphragm 16 is provided in front of the sensor 14, for example a photodiode. As a result of the geometric conditions, light travels at a specific angle from the side where it exits the continuous filter rod 20 through the diaphragm 16 and onto a photo-sensitive surface of sensor 14. When transferred to the surface of the continuous filter rod 20, this means that light travels from the hatched zone I-II onto the photo-sensitive surface of sensor 14.

Proceeding on the assumption that the propagating light cone in the continuous filter rod 20 is also effective on the receiver side, light is captured between the lines 1 and 2. The intersecting points between the two groups of propagating cones mark the two perpendicular planes S1 and S2 in the rod-moving direction, within which intensity fluctuations become noticeable.

If a continuous filter rod 20 with filter segments showing a dark-light transition enters the measuring zone in the beam path of the light cone from light source 12, this dark-light transition intensifies once it reaches the plane S1. The intensity transition is completed at least when it passes through the parallel plane S2.

With the measuring apparatus according to the prior art, shown in FIG. 1, the dimensions and/or the distances of planes S1, S2 are determined by the propagating cone of the light beam fed into the continuous filter rod 20 or the material, the propagating cone of the light source, as well as the aperture angle of the receiving optic. The cone of light propagating in the continuous filter rod 20 or the material depends on the material properties and cannot therefore be influenced from outside.

The propagating light cone from light source 12, which illuminates the distance A-B on the surface of the continuous filter rod 20, depends on the size of the cone angle. The aperture angle of the receiving electronic is determined by the diaphragm 16 dimensions and the size of the photo-sensitive surface of sensor 14.

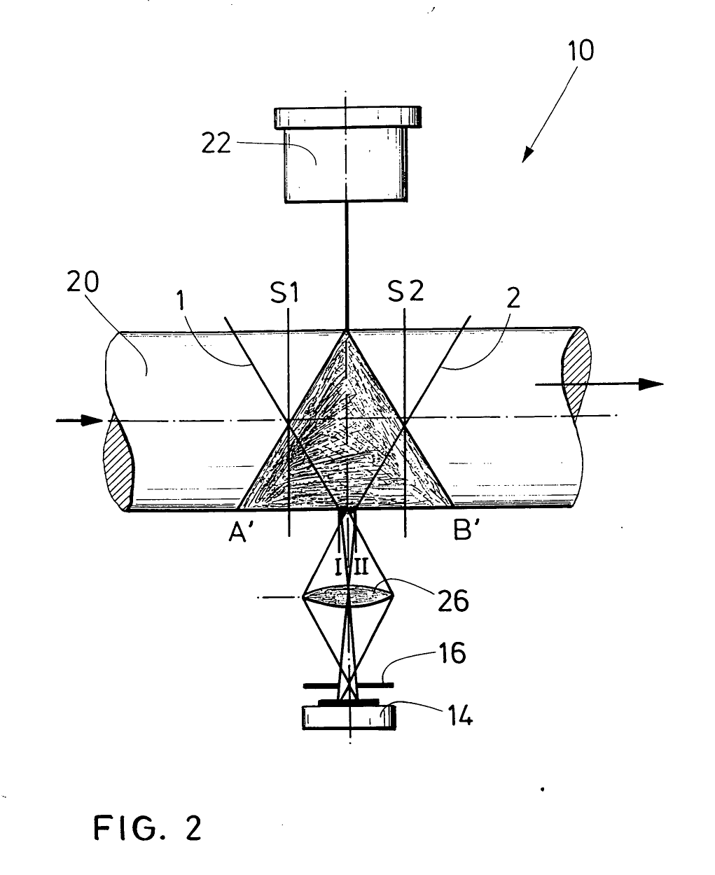

FIG. 2 shows a testing apparatus 10 according to the invention, provided with a laser light source 22. A line-shaped beam from the laser light source 22 is directed point-shaped or fan-shaped onto the continuous filter rod 20, so that at the light-beam entrance point, light is introduced point-shaped and perpendicular into the continuous filter rod 20. From this point of entrance, the light propagates in the manner of a cone inside the continuous filter rod 20, so that on the side where it leaves the continuous filter rod 20, the light is distributed as a result of scattering in the region of exit point A′-B′.

In addition, the influence of the aperture angle for the receiving optic is minimized on the exit side in that a lens 26 with a diaphragm 16 is provided as an imaging device, so that light passing through the filter rod only within the short section I-II on the surface of the continuous filter rod 20 impinges on the photo-sensitive surface of sensor 14. As a result, the distance between the two planes S1, S2 is also clearly reduced.

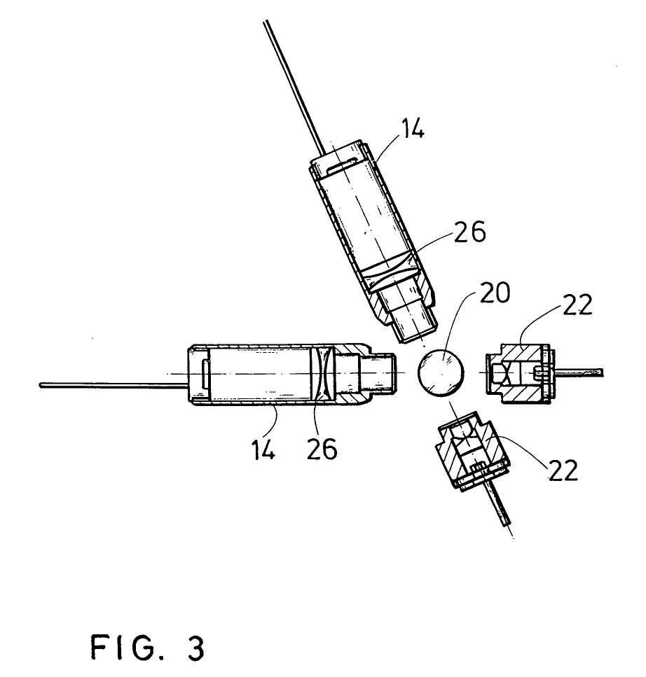

FIG. 3 shows a different arrangement for testing a continuous filter rod 20, composed of filter segments, wherein this embodiment provides for two measuring devices arranged transverse to the conveying direction of the continuous filter rod 20, so that in one plane the continuous filter rod 20 is admitted with light from two laser light sources 22. As a result, interfering influences which could increase the distance between the two planes S1, S2 are for the most part eliminated.

The invention has been described in detail with respect to preferred embodiments, and it will now be apparent from the foregoing to those skilled in the art, that changes and modifications may be made without departing from the invention in its broader aspects, and the invention, therefore, as defined in the appended claims, is intended to cover all such changes and modifications that fall within the true spirit of the invention.

1. An apparatus for testing a rod-shaped article in the tobacco industry, comprising:
a source of light for illuminating the rod-shaped article;
an imaging device disposed for forming an image of at least a portion of light transmitted through the article;
a sensor having a surface on which the image is formed and detecting an intensity of the light in the image.

2. The apparatus according to claim 1, wherein the imaging device comprises at least one optical lens.

3. The apparatus according to claim 1, wherein the light source, the sensor and the imaging device constitute a measuring device, and the apparatus includes at least two of the measuring devices for testing the rod-shaped article.

4. The apparatus according to claim 3, wherein the measuring devices are arranged transverse to the longitudinal axis of the article.

5. The apparatus according to claim 4, wherein the measuring devices are arranged in a single plane.

6. The apparatus according to one claim 1, wherein the light source comprises a laser light source.

7. The apparatus according to claims 1, wherein the imaging device directs the transmitted light along a beam path toward the sensor and the apparatus further includes at least one diaphragm arranged in the beam path between the imaging device and the sensor.

8. A combination comprising a machine in the tobacco industry for producing a rod-shaped article and an apparatus according to claim 1 arranged for testing the rod-shaped article.

9. A method for testing a rod-shaped article in the tobacco industry, comprising:
illuminating the article with light;
imaging, at least in part, light which is transmitted through the article onto a sensor; and
detecting an intensity of the imaged light with the sensor.

10. The method according to claim 9, wherein the illuminating step includes illuminating the article with a laser light source.

11. The method according to claim 9, wherein the illuminating step includes illuminating the article with at least two light sources.
